(19) United States
(12) Patent Application Publication
(10) Pub. No.: US 2025/0345701 A1
(43) Pub. Date: Nov. 13, 2025

(54) Automated Pop-Out Match Bingo Game with Educational Cards

(71) Applicant: Beini MO, arcadia, CA (US)

(72) Inventor: Beini MO, arcadia, CA (US)

(21) Appl. No.: 18/660,320

(22) Filed: May 10, 2024

(51) Int. Cl. A63F 3/06; A63F 11/00; G09B 5/02

(52) U.S. Cl. CPC A63F 3/062; A63F 11/0074; G09B 5/02; A63F 2011/0083

(57) ABSTRACT

The Automated Pop-Out Match Bingo Game with Educational Cards is an innovative gaming device that brings together the fun of traditional match bingo with the benefits of educational content and automation. Unlike conventional match bingo games where players manually push cards out of molds, our invention automates this process, allowing cards to pop out with a simple press. This feature not only saves time but also adds an element of excitement to the gameplay. The game includes a wide range of learning cards covering various subjects such as vocabulary, mathematics, and geography, providing players with opportunities for cognitive development while they play. With customizable gameplay options, including timed challenges and multiplayer modes, players can tailor their gaming experience to their preferences and skill levels. Overall, the Automated Pop-Out Match Bingo Game with Educational Cards offers a unique and engaging way for players of all ages to have fun while learning.

### BACKGROUND

### Field of the Invention

Embodiments of the present invention pertain to gaming devices and educational tools, particularly to an automated pop-out match bingo game incorporating various types of learning cards. Unlike traditional match bingo games where players manually push cards out of molds, this upgraded version automates the process, enabling cards to pop out with a simple press. The game aims to enhance cognitive skills, memory, and learning in players, offering a fun and interactive way to engage with educational content such as English words, mathematics, and other matching concepts.

### Description of the Related Art

Traditional match bingo games involve players manually pushing cards out of a mold to match images or numbers called out by a game leader. This process can be cumbersome, especially for younger players or those with limited dexterity. Despite this, the traditional game format remains popular in both educational and recreational settings. According to industry reports, the global market for board games was valued at over $11 billion in 2020, indicating a significant market for these types of games.

In recent years, there has been a significant surge in the development of educational games that aim to blend learning with entertainment. These games come in various forms, including digital apps, board games, and interactive toys. The goal of these educational games is to make learning fun and engaging for players of all ages. By incorporating elements of gameplay into educational content, developers seek to enhance retention and engagement among learners. For example, digital apps may use gamified quizzes or challenges to teach subjects like math or language arts, while board games may incorporate educational themes and mechanics into their gameplay. This trend reflects a growing recognition of the effectiveness of learning through play and has led to the creation of a diverse range of educational products catering to different interests and learning styles.

Another notable trend in the domain of board games is the increasing automation of gameplay mechanics. Board game designers are introducing mechanisms that streamline gameplay and reduce manual effort for players. For instance, some games feature electronic components or mechanical devices that handle tasks such as dice rolling or card shuffling. Your press-and-pop mold aligns with this trend by offering a convenient and user-friendly experience. By automating the card dispensing process, your game eliminates the need for players to manually push cards out of the mold, making gameplay smoother and more enjoyable. This automation not only enhances the overall gaming experience but also increases accessibility, particularly for younger players or those with limited dexterity. As consumers seek games that are easier to set up and play, the demand for automated board games continues to grow, making your invention well-positioned in the market.

Moreover, there's a growing demand for customizable learning tools that allow educators and parents to tailor learning experiences to the specific needs and interests of learners. Many educational products now offer options for customization, enabling users to personalize their learning journey. Your game fits into this trend by offering various card sets covering different subjects. Whether it's English words, math concepts, geography, science, or history, the modular design of your game allows for easy swapping of card sets, ensuring adaptability to different learning objectives or preferences. This flexibility not only enhances engagement but also caters to diverse learning styles and interests. As educators and parents increasingly seek tools that can be customized to meet the unique needs of learners, your invention provides a valuable solution that combines the benefits of gameplay with educational content. By offering a customizable and interactive learning experience, your game has the potential to appeal to a wide range of users and contribute to the growing market for educational products.

By looking at prior art multiple advancements have been seen. For instance, a U.S. Pat. No. 5,141,235A relates to an educational card game. The educational card game adapted to be played on a geographical game board bearing a continental area with countries marked and outlined therein. The outlined countries of the game board are geographically shaped and removed similar to puzzle pieces whereby each are adapted to fit with one another and to overlie the outlined country space. The game is played similar to gin rummy, whereby educational game cards with specific geographical features and information are used for the card playing aspect of the game. The players compete for desired cards, the accumulation of which entitles one player to win each round. The players, after each round is over, collect country board pieces which are added to a player's point totals. The game is completed when all of the country board pieces have been collected or a predetermined point total has been reached.

A U.S. Pat. No. 5,690,336A presents an educational card game. The educational game relates to the identification of minor political and geographical areas within a major political and geographical area. The game includes a map representing minor political and geographical areas within the major political and geographical area, a master deck containing minor political boundary cards, boundary border cards, fresh water cards within the major political and geographical area, air border cards, and quiz cards, a sub-division deck containing cards presenting facts relating to minor political and geographical areas within the major political and geographical area, a capitol deck containing capitol cards for each minor political area, and a quiz point deck, with each quiz card presenting a questions that relate to the minor political and geographical areas. The game presents various stages of difficulty and applies to states within a country or to countries within a continent.

The US patent 2,016,0339332 relates to an educational card game system and method of use. The educational card game, designed primarily for children. A designated deck of cards are broken into several sets, with the respective sets designated on the backs of the cards. The front of the cards has at least one colored symbol. The cards, and therefore symbols on the cards, can be designated as number, letter shape, image or other symbol, depending on what the child is to team from that particular deck of cards. The cards are meant to be played as one of a number of games, so that players can learn while having fun. In one embodiment, a player with a deck of cards attempts to match either the color or symbol of a card atop a “play” pile.

A U.S. Pat. No. 6,109,609 relates to educational card game and method. The educational card game and method for play comprises a plurality of cards with each card having a surface with indicia imprinted thereon. Each card further includes a raised flange extending across an end of the card. The card game further includes a game board having a channel formed therein for releasably retaining each raised flange such that the cards may be selectably positioned on the game board to display a desired sequence of the indicia. A magnetic strip extends through the channel and selectably cooperates with a metallic element on each raised flange to enhance the adherence of each card to the game board. Points may be awarded as game players successively position cards on the game board.

The current invention aims to present an automated match bingo game offers several advantages over traditional versions. Firstly, the automation of card dispensing streamlines gameplay, making it smoother and more enjoyable for players of all ages. Secondly, the inclusion of various learning cards covering subjects such as English words, math, geography, science, and history transforms the game into a versatile educational tool suitable for classrooms, homeschooling, or family learning sessions. Thirdly, the ease of use and flexibility of the game ensure high replay value, keeping players engaged over multiple sessions. Additionally, the automated mechanism increases accessibility, particularly for younger players or those with limited dexterity, contributing to a more inclusive gaming experience. Finally, the invention aligns with market trends towards automation in board games and the growing demand for customizable learning tools, positioning it well in the competitive market for educational and recreational games.

None of the previous inventions and patents, taken either singly or in combination, is seen to describe the instant invention as claimed. Hence, the inventor of the present invention proposes to resolve and surmount existent technical difficulties to eliminate the aforementioned shortcomings of prior art.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims and abstract as a whole.

It is therefore the purpose of the invention to alleviate at least to some extent one or more of the aforementioned problems of the prior art and/or to provide the relevant public with a suitable alternative thereto having relative advantages.

The primary object of the invention is related to the mechanism of enhancing user engagement by providing an automated pop-out mechanism, eliminating the need for manual card pushing and streamlining the gameplay experience.

Another desirable object of the present invention is to promote cognitive development and learning through the incorporation of diverse educational content, including vocabulary, mathematics, geography, and other subjects, stimulating players' minds while they play.

It is also the objective of the invention is to offer customization options, allowing players to select specific sets of learning cards and adjust the difficulty level of the game, catering to individual preferences and skill levels.

It is moreover the objective of the invention to facilitate multiplayer gameplay, encouraging social interaction and collaboration among players as they compete or work together to complete bingo patterns and achieve common goals.

It is moreover the objective of the invention to provide timed challenges, adding excitement and a sense of urgency to the gameplay while testing players' speed and accuracy in completing patterns.

It is further the objective of the invention to offer a wide range of gameplay options, including various modes such as standard match bingo, timed challenges, and multiplayer modes, ensuring hours of entertainment and enjoyment for players of all ages.

It is also the objective of the invention to promote family bonding and educational activities by offering a fun and interactive way for family members to learn and play together.

It is further the objective of the invention to improve motor skills and hand-eye coordination as players interact with the gaming device to press buttons or levers and match cards to bingo boards.

It is moreover the objective of the invention to provide a modern and convenient alternative to traditional match bingo games with its electronic version, featuring a digital interface for displaying cards and bingo boards.

It is also the objective of the invention to make learning fun and accessible to all, encouraging lifelong learning and curiosity through an engaging and educational gaming experience.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

In its preferred embodiment, the current invention introduces an automated pop-out match bingo game with educational cards, revolutionizing the traditional match bingo experience. In one embodiment, the gaming device comprises a mold constructed with compartments designed to hold cards. The mold is equipped with an innovative automated mechanism for releasing cards upon user command. This mechanism, which can be activated by a button or lever, provides users with a simple and efficient way to release cards from the mold without the need for manual intervention.

As per preferred embodiments, each card in the gaming device contains unique content, such as images, words, or mathematical equations, designed to engage and educate players. These educational cards cover a wide range of subjects, including vocabulary, mathematics, geography, history, and science-related topics. The content on the cards can be customized based on user preferences and learning objectives, allowing players to tailor their gaming experience to their specific interests and skill levels.

As per further embodiments, to play the match bingo game, players are presented with bingo boards featuring a grid layout. Players aim to match the cards released from the mold with corresponding items on their bingo boards to complete rows, columns, or predetermined patterns. The automated mechanism of the gaming device adds excitement to the gameplay, as players eagerly anticipate the cards popping out with a simple press of a button or lever.

As per further embodiments, the match bingo game offers various gameplay options to enhance user experience. Players can select specific sets of learning cards from a plurality of educational topics, allowing for customization and adaptability. Additionally, players can adjust the difficulty level of the game by selecting different sets of learning cards, providing a challenge suitable for players of all skill levels.

As per additional embodiments, the match bingo game can be played in multiplayer mode, where multiple players compete against each other or work together in teams to achieve common goals. Players can also engage in timed challenges, racing against the clock to match cards and complete bingo patterns within a specified time limit. Bonuses or penalties may be awarded based on players' speed and accuracy, adding an extra layer of excitement and competitiveness to the game.

As per another embodiment, an electronic version of the match bingo game is provided, featuring a digital interface for displaying cards and bingo boards. This electronic version includes a virtual mechanism for releasing cards upon user command, offering a modern and convenient alternative to the traditional physical gaming device. Overall, the present invention provides a unique and enriching gaming experience that combines the excitement of match bingo with the benefits of educational content and automation.

While a specific embodiment has been shown and described, many variations are possible. With time, additional features may be employed. The particular shape or configuration of the platform or the interior configuration may be changed to suit the system or equipment with which it is used.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

We claim:

1. A gaming device comprising a mold with compartments for holding cards, wherein said mold is equipped with an automated mechanism for releasing cards upon user command.
The gaming device of claim 1, wherein the automated mechanism comprises a button or lever for activating the release of cards from the mold;
The gaming device of claim 1, wherein the players match cards with corresponding items on bingo boards to complete rows, columns, or patterns;
gaming device of claim 1, wherein the bingo boards feature a grid layout and players aim to complete predetermined patterns to win the game;
The gaming device of claim 1, wherein said card set comprises cards featuring images, words, mathematical equations, or other educational content; and,
The gaming device of claim 1, wherein the educational content includes vocabulary, mathematics, geography, history, or science-related topics.

2. A method of playing a match bingo game, comprising the steps of selecting a set of learning cards, loading said cards into the compartments of the gaming device of claim 1, and matching said cards with corresponding items on bingo boards.
The method of claim 2, wherein the game comprises the step of pressing a button or lever to release cards from the mold of the gaming device;
The method of claim 2, wherein the game includes customizable match bingo game, wherein players can select specific sets of learning cards from a plurality of educational topics;
The method of claim 2, wherein the players can adjust the difficulty level of the game by selecting different sets of learning cards;
The method of claim 2, wherein the players can compete against each other or work together in teams to achieve common goals;
The method of claim 2, wherein the players race against the clock to match cards and complete bingo patterns within a specified time limit;
The method of claim 2, wherein the players ern bonuses or penalties based on their speed and accuracy in completing patterns; and,
The method of claim 2, wherein the game includes a digital interface for displaying cards and bingo boards, and a virtual mechanism for releasing cards upon user command.
